(19) United States
(12) Patent Application Publication
(10) Pub. No.: US 2022/0236783 A1
(43) Pub. Date: Jul. 28, 2022

(54) SERVICE-ORIENTED ARCHITECTURE IN A VEHICLE

(71) Applicant: Ford Global Technologies, LLC, Dearborn, MI (US)

(72) Inventors: Francis Obiagwu, Warren, MI (US); Cheri Lyn Hansen, Canton, MI (US); Harsh Bhate, Dearborn, MI (US)

(73) Assignee: Ford Global Technologies, LLC, Dearborn, MI (US)

(21) Appl. No.: 17/159,266

(22) Filed: Jan. 27, 2021

(51) Int. Cl. G06F 1/3234

(52) U.S. Cl. CPC G06F 1/3234

(57) ABSTRACT

A computer includes a processor and a memory storing instructions executable by the processor to receive a plurality of read rates from respective subscribers in a vehicle, instruct a publisher to publish at a highest read rate of the read rates, and in response to the subscriber with the highest read rate of the subscribers being offline, instruct the publisher to publish at a next highest read rate of the read rates.

### BACKGROUND

A service-oriented architecture is a software environment in which applications on a network act as publishers or subscribers for message topics. A message topic is a category of data or update for which messages can be sent between applications. An application can be a publisher or a subscriber with respect to a specific message topic. A publisher for a given message topic sends messages about the message topic to subscribers to that message topic.

### BRIEF DESCRIPTION OF THE DRAWINGS

FIG. 1 is a block diagram of an example vehicle.

FIG. 2 is a block diagram of an example service-oriented architecture of the vehicle.

FIG. 3 is a process flow diagram of an example process for setting a publication rate of a publisher in the service-oriented architecture.

### DETAILED DESCRIPTION

The system described herein includes improvements that can provide low power consumption and low bandwidth consumption for a network hosting a service-oriented architecture on board a vehicle. Here is an example of a service-oriented architecture on a vehicle: a message topic can be image data from a camera, a publisher can be an application on a control module for a camera, subscribers can be applications on control modules making decisions using the image data, and read rates can be frame rates, e.g., in frames per second. A computer receives read rates, e.g., frame rates, from the subscribers to the message topic, e.g., the image data, on the network and instructs the publisher for that message topic, e.g., the control module for the camera, to publish at a highest read rate of the read rates, and in response to the subscriber with the highest read rate going offline, the computer instructs the publisher to publish at a next highest read rate of the read rates. The publisher is thus publishing messages at no more than the rate at which the most demanding subscriber will read the messages. As subscribers go offline, the computer dynamically keeps the publisher up to date on the read rate at which to publish. Power consumption to publish the messages and bandwidth consumed by the messages are thus kept low.

A computer includes a processor and a memory storing instructions executable by the processor to receive a plurality of read rates from respective subscribers in a vehicle; instruct a publisher to publish at a highest read rate of the read rates; and in response to the subscriber with the highest read rate of the subscribers being offline, instruct the publisher to publish at a next highest read rate of the read rates.

The instructions may include instructions to, in response to the subscribers being offline, instruct the publisher to stop publishing.

The instructions may include instructions to receive power-management data, and determine that the subscriber with the highest read rate is offline by using the power-management data.

The subscribers may be first subscribers, the instructions may include instructions to select the first subscribers from a plurality of subscribers, and the subscribers may include the first subscribers and second subscribers. Selecting the first subscribers may include excluding the second subscribers.

The instructions to select the first subscribers may be performed in response to a constraint on publishing by the publisher. The constraint may be a low-power state of a network including the publisher and the subscribers.

The constraint may be a low-bandwidth state of a network including the publisher and the subscribers.

Selecting the first subscribers may include excluding the second subscribers. The instructions may include instructions to select the first and second subscribers from the subscribers in response to a lack of the constraint on publishing by the publisher, and then instruct the publisher to publish at a highest read rate of the read rates of the first and second subscribers.

A method includes receiving a plurality of read rates from respective subscribers in a vehicle; instructing a publisher to publish at a highest read rate of the read rates; and in response to the subscriber with the highest read rate of the subscribers being offline, instructing the publisher to publish at a next highest read rate of the read rates.

The method may further include, in response to the subscribers being offline, instructing the publisher to stop publishing.

The method may further include receiving power-management data, and determining that the subscriber with the highest read rate is offline by using the power-management data.

The subscribers may be first subscribers, the method may further include selecting the first subscribers from a plurality of subscribers, and the subscribers may include the first subscribers and second subscribers. Selecting the first subscribers may include excluding the second subscribers.

Selecting the first subscribers may be performed in response to a constraint on publishing by the publisher. The constraint may be a low-power state of a network including the publisher and the subscribers.

The constraint may be a low-bandwidth state of a network including the publisher and the subscribers.

The subscribers may include the first subscribers and second subscribers, and selecting the first subscribers may include excluding the second subscribers. The method may further include selecting the first and second subscribers from the subscribers in response to a lack of the constraint on publishing by the publisher, and then instructing the publisher to publish at a highest read rate of the read rates of the first and second subscribers.

With reference to the Figures, a computer 102 includes a processor and a memory storing instructions executable by the processor to receive a plurality of read rates from respective subscribers 104 in a vehicle 100, instruct a publisher 106 to publish at a highest read rate of the read rates, and in response to the subscriber 104 with the highest read rate of the subscribers 104 being offline, instruct the publisher 106 to publish at a next highest read rate of the read rates.

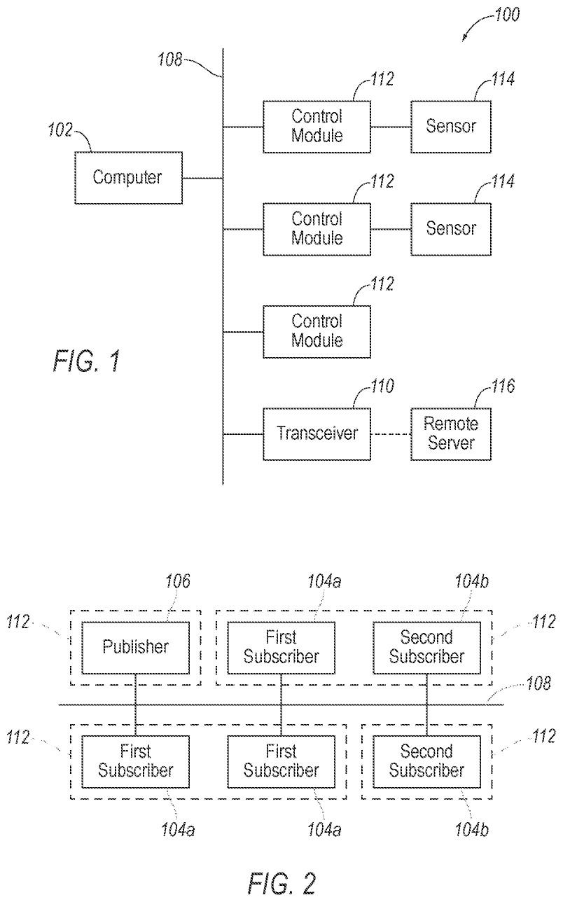

With reference to FIG. 1, the vehicle 100 may be any suitable type of automobile, e.g., a passenger or commercial automobile such as a sedan, a coupe, a truck, a sport utility, a crossover, a van, a minivan, a taxi, a bus, etc. The vehicle 100, for example, may be autonomous. In other words, the vehicle 100 may be autonomously operated such that the vehicle 100 may be driven without constant attention from a driver, i.e., the vehicle 100 may be self-driving without human input.

The computer 102 is a microprocessor-based computing device, e.g., a generic computing device including a processor and a memory, an electronic controller or the like, a field-programmable gate array (FPGA), an application-specific integrated circuit (ASIC), etc. The computer 102 can thus include a processor, a memory, etc. The memory of the computer 102 can include media for storing instructions executable by the processor as well as for electronically storing data and/or databases, and/or the computer 102 can include structures such as the foregoing by which programming is provided. The computer 102 can be multiple computers coupled together.

The computer 102 may transmit and receive data through a communications network 108 such as a controller area network (CAN) bus, Ethernet, WiFi, Local Interconnect Network (LIN), onboard diagnostics connector (OBD-II), and/or by any other wired or wireless communications network. The computer 102 may be communicatively coupled to a plurality of control modules 112, a transceiver 110, and other components via the communications network 108.

The control modules 112 are microprocessor-based computing devices, e.g., generic computing devices each including a processor and a memory, electronic controllers or the like, field-programmable gate arrays (FPGA), application-specific integrated circuits (ASIC), etc. Each control module 112 can thus include a processor, a memory, etc. The memory of each control module 112 can include media for storing instructions executable by the processor as well as for electronically storing data and/or databases, and/or each control module 112 can include structures such as the foregoing by which programming is provided. The control modules 112 can operate different systems in the vehicle 100, e.g., a body control module 112, a powertrain control module 112, a restraint control module 112, etc. The control modules 112 can receive data from sensors 114 connected to the control modules 112.

The vehicle 100 includes the sensors 114 coupled to respective control modules 112. The sensors 114 may provide data about operation of the vehicle 100, for example, wheel speed, wheel orientation, and engine and transmission data (e.g., temperature, fuel consumption, etc.). The sensors 114 may detect the location and/or orientation of the vehicle 100. For example, the sensors 114 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 114 may detect the external world, e.g., objects and/or characteristics of surroundings of the vehicle 100, such as other vehicles, road lane markings, traffic lights and/or signs, pedestrians, etc. For example, the sensors 114 may include radar sensors, scanning laser range finders, light detection and ranging (LIDAR) devices, and image processing sensors such as cameras.

The transceiver 110 may be adapted to transmit signals wirelessly through any suitable wireless communication protocol, such as cellular, Bluetooth®, Bluetooth® Low Energy (BLE), ultra-wideband (UWB), WiFi, IEEE 802.11a/b/g/p, cellular-V2X (CV2X), Dedicated Short-Range Communications (DSRC), other RF (radio frequency) communications, etc. The transceiver 110 may be adapted to communicate with a remote server 116, that is, a server distinct and spaced from the vehicle 100. The remote server 116 may be located outside the vehicle 100. For example, the remote server 116 may be associated with another vehicle 100 (e.g., V2V communications), an infrastructure component (e.g., V2I communications via Dedicated Short-Range Communications (DSRC) or the like), an emergency responder, a mobile device associated with the owner of the vehicle 100, etc. The transceiver 110 may be one device or may include a separate transmitter and receiver.

With reference to FIG. 2, a service-oriented architecture is implemented on the computer 102, the control modules 112, and the communications network 108. The service-oriented architecture is a software environment, i.e., implemented according to program instructions stored an executable by the computer 102 and/or the control modules 112, in which applications on devices on the communications network 108, e.g., computer 102 and/or control modules 112, act as the publishers 106 or the subscribers 104 for message topics. A message topic is a category of data or update for which messages can be sent between applications. Examples of message topics are different types or categories of data produced by the sensors 114, e.g., a message topic could be image data from cameras or a particular camera, engine temperature from a temperature sensor, position updates from a GPS sensor, etc.

An application is a software program installed on one of the control modules 112, e.g., a data-processing program for one of the sensors 114 such as a camera, a navigation application, a driver-assistance system such as active cruise control, etc. A publisher 106 for a given message topic sends messages about the message topic to subscribers 104 to that message topic; e.g., the data-processing program can be a publisher 106 of image data, and the driver-assistance system can be a subscriber 104 to the image data. For another example, a GPS program can be a publisher 106 of position updates, and the navigation application can be a subscriber 104 to the position updates. Each control module 112 can have multiple applications installed. An application can be a publisher 106 or a subscriber 104 with respect to a specific message topic. The same application can be a publisher 106 for one message topic and a subscriber 104 for a different message topic. An application can also be installed on the remote server 116 and connected to the service-oriented architecture via the transceiver 110, e.g., a social-media application on a mobile device can be a subscriber 104 to image data.

For example, the message topic can be image data from a camera, the publisher 106 can be an application on the control module 112 for the camera, the subscribers 104 can be applications on control modules 112 making decisions using the image data, and the read rates can be frame rates, e.g., in frames per second.

Each subscriber 104 has a read rate for the corresponding message topic. A read rate is how frequently the subscriber 104 will use the data in the messages about the message topic. The read rates are measured in units of messages per unit time, e.g., for image data, frames per second. Each publisher 106 publishes messages about the message topic at a publication rate, which is likewise measured in units of messages per unit time. As described below with respect to a process 300, the publication rate can be varied based on the read rates of the subscribers 104 to the message topic.

The subscribers 104 for a given message topic can have prioritization classifications. A prioritization classification is a category indicating which subscribers 104 will receive messages about the message topic when the messages cannot be delivered to all subscribers 104, e.g., due to a constraint such as a low-power state or low-bandwidth state of the communications network 108. For example, the subscribers 104 can include first subscribers 104a and second subscribers 104b. The first subscribers 104a can receive the messages under all conditions of the communications network 108, and the second subscribers 104b can receive the messages when the communications network 108 is not subject to a constraint. For example, for image data, the driver-assistance system can be a first subscriber 104a, and the social-media application can be a second subscriber 104b. The prioritization classification can instead have more than two levels.

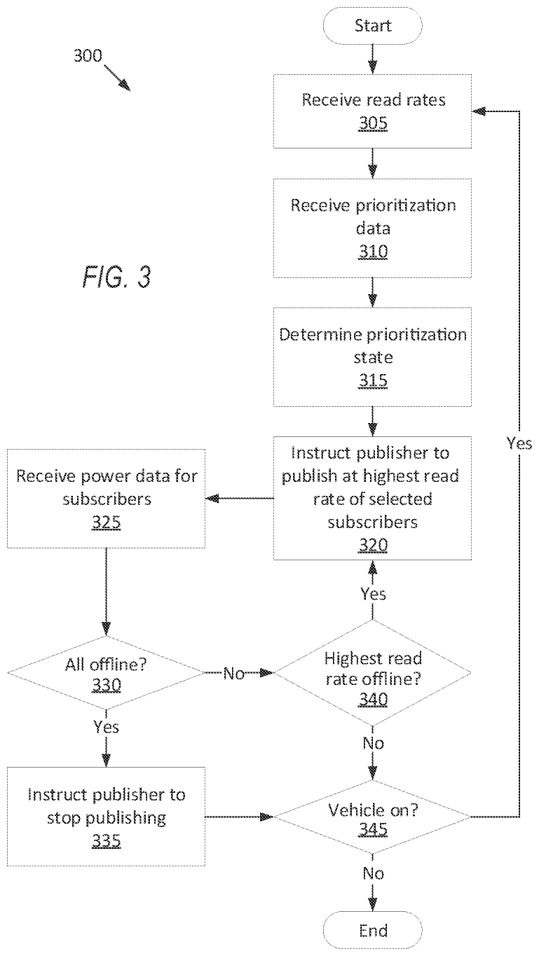

FIG. 3 is a process flow diagram illustrating an exemplary process 300 for setting a publication rate of a publisher 106 in the service-oriented architecture. The memory of the computer 102 stores executable instructions for performing the steps of the process 300 and/or programming can be implemented in structures such as mentioned above. The process 300 is performed for a single publisher 106 publishing messages about a single message topic. As a general overview of the process 300, the computer 102 receives read rates from subscribers 104 to the message topic and prioritization data indicating whether the communications network 108 is subject to a constraint. The computer 102 selects all or a subset of the subscribers 104 based on the prioritization data and instructs the publisher 106 to publish at a highest read rate of the read rates of the selected subscribers 104. The computer 102 receives power-management data for the subscribers 104. If all the subscribers 104 are offline, the computer 102 instructs the publisher 106 to stop publishing. If the subscriber 104 with the highest read rate is offline, the computer 102 instructs the publisher 106 to publish at the next highest read rate of the read rates of the remaining selected subscribers 104. The process 300 continues for as long as the vehicle 100 remains on.

The process 300 begins in a block 305, in which the computer 102 receives a plurality of read rates from respective subscribers 104 to the message topic. Subscribers 104 that are in an offline or sleeping state do not transmit their read rates and are ignored.

Next, in a block 310, the computer 102 receives data relevant to prioritization of the subscribers 104. Specifically, the computer 102 receives data indicating whether a constraint exists on publishing by the publisher 106. A constraint on publishing can be a limitation on the communications network 108. For example, the constraint can be a low-power state of the communications network 108. For another example, the constraint can be a low-bandwidth state of the communications network 108.

Next, in a block 315, the computer 102 determines a prioritization state and selects a subset of subscribers 104 from the plurality of subscribers 104 based on the prioritization state. For example, if each subscriber 104 is either a first subscriber 104a having a comparatively higher priority or a second subscriber 104b having a comparatively lower priority, the computer 102 selects the first and second subscribers 104, i.e., all the subscribers 104, in response to a lack of a constraint on publishing by the publisher 106, and the computer 102 selects just the first subscribers 104a and excludes the second subscribers 104b in response to a constraint on the communications network 108.

Next, in a block 320, the computer 102 instructs the publisher 106 to publish at a highest read rate of the read rates of the subscribers 104 selected in the block 315. For example, if the selected subscribers 104 include three subscribers 104 of image data from the publisher 106, and the selected subscribers 104 have read rates of 10 frames per second (fps), 25 fps, and 50 fps, the publisher 106 publishes at 50 fps. For another example, if the subscribers 104 with the read rates of 10 and 25 fps are first subscribers 104a, the subscriber 104 with the read rate of 50 fps is a second subscriber 104b, and the second subscribers 104b are excluded because of a constraint on the communications network 108, then the publisher 106 publishes at 25 fps.

Next, in a block 325, the computer 102 receives power-management data relating to the subscribers 104. For example, a power-management application can send messages listing which subscribers 104 or which control modules 112 are in an online or active state and which are in an offline or sleeping state. The power-management application can send the messages periodically or upon changes occurring.

Next, in a decision block 330, the computer 102 determines whether all the selected subscribers 104 are offline based on the power-management data. If all the selected subscribers 104 are offline, the process 300 proceeds to a block 335. If at least one selected subscriber 104 is still online, the process 300 proceeds to a decision block 340.

In the block 335, the computer 102 instructs the publisher 106 to stop publishing. After the block 335, the process 300 proceeds to a decision block 345.

In the decision block 340, the computer 102 determines whether the subscriber 104 having the highest read rate of the read rates of the selected subscribers 104 is offline using the power-management data. If the subscriber 104 with the highest read rate is offline, the process 300 returns to the block 320 with the subscriber 104 with the highest read rate excluded from the selected subscribers 104. In the block 320, the computer 102 thus instructs the publisher 106 to publish at the next highest read rate of the read rates of the subscribers 104. If the subscriber 104 with the highest read rate is still online, the process 300 proceeds to the decision block 345.

In the decision block 345, the computer 102 determines whether the vehicle 100 is on. If the vehicle 100 is still on, the process 300 returns to the block 305 to receive the read rates from the subscribers 104 that are online. If the vehicle 100 has been turned off, the process 300 ends.

Computer executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a networked device is generally a collection of data stored on a computer readable medium, such as a storage medium, a random access memory, etc. A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

The disclosure has been described in an illustrative manner, and it is to be understood that the terminology which has been used is intended to be in the nature of words of description rather than of limitation. Use of “in response to” and “upon determining” indicates a causal relationship, not merely a temporal relationship. The adjectives “first” and “second” are used throughout this document as identifiers and are not intended to signify importance, order, or quantity. Many modifications and variations of the present disclosure are possible in light of the above teachings, and the disclosure may be practiced otherwise than as specifically described.

1. A computer comprising a processor and a memory storing instructions executable by the processor to:
in response to a network on board a vehicle experiencing a low-power state that constrains publishing by a publisher on the network, select first subscribers from a plurality of subscribers, the subscribers including first subscribers and second subscribers;
in response to a lack of a constraint on publishing by the publisher, select the first subscribers and the second subscribers;
receive a plurality of read rates from the respective selected subscribers in the vehicle;
instruct the publisher to publish at a highest read rate of the read rates; and
in response to the subscriber with the highest read rate of the selected subscribers being offline, instruct the publisher to publish at a next highest read rate of the read rates.

2. The computer of claim 1, wherein the instructions include instructions to, in response to the subscribers being offline, instruct the publisher to stop publishing.

3. The computer of claim 1, wherein the instructions include instructions to receive power-management data of the subscribers from a power-management application, and determine that the subscriber with the highest read rate is offline by using the power-management data.

4. (canceled)

5. The computer of claim 1, wherein selecting the first subscribers includes excluding the second subscribers.

6. (canceled)

7. (canceled)

8. The computer of claim 1, wherein the instructions further include instructions to, in response to the network experiencing a low-bandwidth state that constrains publishing on the network, select the first subscribers from the subscribers.

9. (canceled)

10. (canceled)

11. A method comprising:
in response to a network on board a vehicle experiencing a low-power state that constrains publishing by a publisher on the network, selecting first subscribers from a plurality of subscribers, the subscribers including first subscribers and second subscribers;
in response to a lack of a constraint on publishing by the publisher, select the first subscribers and the second subscribers;
receiving a plurality of read rates from the respective selected subscribers in the vehicle;
instructing the publisher to publish at a highest read rate of the read rates; and
in response to the subscriber with the highest read rate of the selected subscribers being offline, instructing the publisher to publish at a next highest read rate of the read rates.

12. The method of claim 11, further comprising, in response to the subscribers being offline, instructing the publisher to stop publishing.

13. The method of claim 11, further comprising receiving power-management data of the subscribers from a power-management application, and determining that the subscriber with the highest read rate is offline by using the power-management data.

14. (canceled)

15. The method of claim 11, wherein selecting the first subscribers includes excluding the second subscribers.

16. (canceled)

17. (canceled)

18. The method of claim 11, further comprising, in response to the network experiencing a low-bandwidth state that constrains publishing on the network, selecting the first subscribers from the subscribers.

19. (canceled)

20. (canceled)

21. The computer of claim 1, wherein publishing by the publisher includes transmitting image data from a camera of the vehicle, and the read rates are frame rates.

22. The method of claim 11, wherein publishing by the publisher includes transmitting image data from a camera of the vehicle, and the read rates are frame rates.
